(19) United States
(12) Patent Application Publication
(10) Pub. No.: US 2003/0148796 A1
(43) Pub. Date: Aug. 7, 2003

(54) Apparatus and method of subscribing to content for wireless application protocol transceivers

(76) Inventor: Paul Bermel, Nashville, TN (US)

Correspondence Address: STITES & HARBISON, PLLC, 400 W MARKET ST, SUITE 1800, LOUISVILLE, KY, 40202-3352, US

(21) Appl. No.: 10/384,331

(22) Filed: Mar. 7, 2003

Related U.S. Application Data
(63) Continuation of application No. 09/791,161, filed on Feb. 22, 2001, now abandoned.
(60) Provisional application No. 60/184,440, filed on Feb. 23, 2000.

(51) Int. Cl. H04B 1/38; H04Q 7/20

(52) U.S. Cl. 455/566; 455/466

(57) ABSTRACT

Apparatus (1) for users of wireless transceivers (14) of a communication service (12) to subscribe selectively to content messages provided (32) periodically to wireless transceivers by a content provider service (18). A message display device (22) receives and displays a message from the content provider (18) including a solicitation (26a) for subscribing to subscription-based content messages provided by the content provider service. The user communicates a signal from the wireless transceiver in response to the solicitation to identify the wireless transceiver for which the content provider is to initiate providing subscription-based content messages. A method for users of wireless transceivers to subscribe to content provided by content providers is disclosed.

### TECHNICAL FIELD

The present invention relates to obtaining content for wireless application protocol transceivers. More particularly, the present invention relates to a method and apparatus for subscribing to content provided periodically to wireless application protocol transceivers.

### BACKGROUND OF THE INVENTION

Wireless Application Protocol (WAP) is an industry standard for connecting wireless devices such as telephones to global interactive information networks. Information, such as news, features, advertising, promotional materials, interactive technical support, and the like, are commonly referred to as “content.” Content is generally provided by various information sources, including news services, mobile telecommunications services, sources maintaining sites on global interactive networks, and the like. Typically, the transceivers are mobile phones which are WAP compatible. With such transceivers, not only can mobile cellular phone calls be made, but content can be provided to the display screen on the transceiver. Content includes financial information, news, sports information, weather, advertising, and other such information of use or interest to persons.

Heretofore, subscriptions to content messages by users of wireless transceivers have been provided, but the subscription process is unsatisfactory. The content is generally remote from the wireless transceiver and the user, and may require completing and mailing subscription forms and agreements, as well as billing and payment activities.

Accordingly, there is a need in the art for users of wireless transceivers to more easily subscribe to content provided by others for display on the selected wireless transceiver. It is to such that the present invention is directed.

### SUMMARY OF THE PRESENT INVENTION

The present invention meets the need in the art by providing apparatus and method for subscribing to content for display on selected wireless transceivers. The apparatus of the present invention provides for users of wireless transceivers to subscribe selectively to content messages provided periodically to wireless transceivers by a content provider service. The apparatus comprises a communication service that provides wireless communication for a plurality of wireless transceivers operated by users of the communication service. A content provider service provides at least one subscription-based content message for communication to and display on selected ones of the plurality of wireless transceivers. At least one message display device receives and displays a message from the content provider for visual access by the users. The message includes a solicitation for subscribing to said subscription-based content messages provided by said content provider service. A signal receiver is provided for receiving a signal from one wireless transceiver caused by the user thereof to be communicated in response to the solicitation. The signal identifies the wireless transceiver for which the content provider is to initiate providing subscription-based content messages.

In another aspect, the present invention provides a method for users of wireless transceivers to subscribe selectively to content messages provided periodically to wireless transceivers by a content provider service, comprising the steps of:

(a) providing wireless communication for a plurality of wireless transceivers operated by users of a communication service;

(b) communicating at least one subscription-based content message by a content provider service for communication to and display on selected ones of the plurality of wireless transceivers;

(c) displaying a message from the content provider on at least one message display device available for visual access by said users, said message including a solicitation for subscribing to said at least one subscription-based content message provided by said content provider service; and

(d) communicating a signal from at least one wireless transmitter by the user thereof in response to the solicitation, said signal identifying said one wireless transceiver for which the content provider is to initiate providing subscription-based content messages.

Objects, advantages, and features of the present invention will become more readily apparent, upon a reading of the following detailed description in conjunction with the claims and the appended drawings.

### BRIEF DESCRIPTION OF THE DRAWING

FIG. 1 is a schematic illustration of an apparatus and method for subscribing to content for information transceivers.

### DETAILED DESCRIPTION OF THE PREFERRED EMBODIMENT

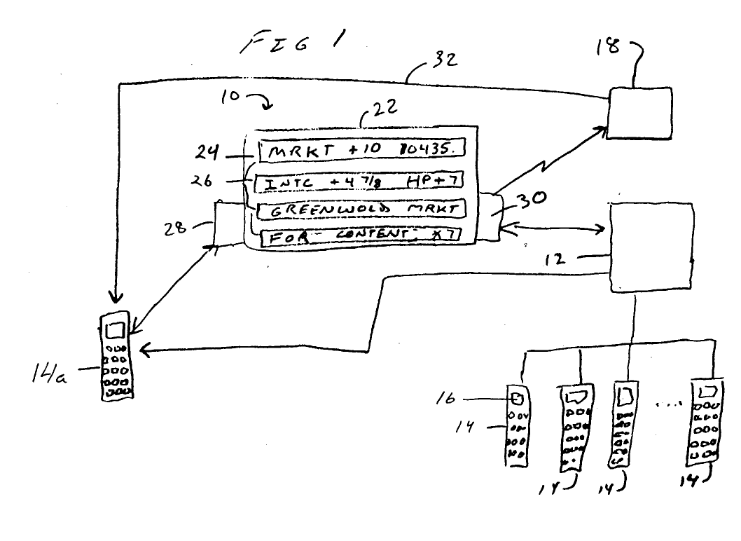

Referring now in more detail to the drawing, in which like numerals indicate like parts throughout the several views, FIG. 1 illustrates a schematic illustration of a content information system 10 having a wireless network provider 12 that provides interactive telecommunications wireless services to a plurality of users. Each user is provided with a wireless transceiver 14 whereby mobile cellular telephone communication may be established between the person holding the transceiver 14 and other such receivers for wired telephones provided by conventional telephone Systems. Each transceiver 14 is provided with a display screen 16 for display of information. Such information not only includes outgoing and incoming telephone information such as numbers, duration of calls, and the like, the display screen 16 also can display content provided by the mobile telecommunications services provider 12 or by one of a plurality of independent information providers 18.

The system also includes an advertising device 22 for providing information content to persons in a public area. For example, the display device 22 is preferably mounted in train stations of mass transit systems, as well as other public areas. Information content is communicated from an information source, such as the provider 18, for display on a display panel 24 of the device 22. For example, the display panel 24 comprises a LED display of four lines 26 each with a plurality of addressable characters for a display of letters, symbols, and numbers. A controller 28 operates the display of messages on the display panel 24. The controller includes a plurality of memory slots for storing messages to be displayed on the display panel 24. The messages for display are received by a communicator 30. The communicator communicates with providers of the messages, such as the provider 18. However, in a preferred embodiment, the message content for the display device 22 is provided from a central organization which owns and operates the display devices at various locations. Persons interested in providing content such as advertisers, news sources, weather sources, and other information providers, contract with the central source for leasing display times for displaying the information on the display device 22.

The content providers 18 are interested in not only in providing content to the display device 22, but, on a subscription basis, also providing content directly to one or more of the wireless transceivers 14. The subscription basis may be paid or free of cost, and may include advertising. The present invention provides a method whereby the content provider 18 can offer subscriptions for content provided 32 directly to the transceivers 14. The owner of the transceiver 14a is in the vicinity of the display device 22. He observes the financial information, or other content displayed on the display panel 24. The display panel includes a solicitation from the provider 18 for a subscription for content. The line 26a in the display panel 24 includes the solicitation “for content *7”. This refers to the use of the touch pad numbers and symbols on the transceiver 14a to communicate a request to subscribe to the periodic transmission of similar content by a provider 18. The provider 18 will then for the duration of the subscription communicate the content directly to the transceiver 14a. The subscription is entered, in the illustrated embodiment, by the person pressing the *7 button to communicate a wireless signal from the transceiver 14 to the telecommunications service provider 12. Other signaling mechanisms may be used to communicate the subscription signal.

The telecommunications service provider 12 uses the transceiver number or code to obtain the customer name and billing information. The telecommunications service provider 12 communicates the name and billing address of the transceiver owner together with the transceiver number to the content provider 18. The content provider 18 then initiates a subscription to the transceiver 14a. The content provider 18 then communicates the content periodically directly with the transceiver 14a by using the transceiver code number or by the telephone number of the transceiver.

In one embodiment, billing for the subscription from the content provider 18 is handled by the telecommunications service provider 12 which includes the subscription cost on the invoice for the services to the particular subscriber, together with other telecommunication services provided by the services provider 12. It is noted that the telecommunications service provider 12 may also provide subscription-based content.

An alternate embodiment also facilitates mobile commerce. In addition to content, the display device 22 displays graphics and advertising for goods and services provided by others such as the provider 18. The display includes a control code, such as the *7 described above. The person using the transceiver enters the control code for purchasing the advertising goods or services. The telecommunications service 12 again coordinates the purchase between the person and the provider 18, as discussed above.

The present invention accordingly provides an interactive method for a WAP transceiver to subscribe to content shown on public area informational displays as well as effect mobile commerce by purchasing goods and services promoted on such informational displays.

What is claimed is:

1. An apparatus for users of wireless transceivers to subscribe selectively to content messages provided periodically to wireless transceivers by a content provider service, comprising:
a communication service providing wireless communication for a plurality of wireless transceivers operated by users of the communication service;
a content provider service providing at least one subscription-based content message for communication to and display on selected ones of the plurality of wireless transceivers;
at least one message display device that receives and displays a message from the content provider available for visual access by said users, said message including a solicitation for subscribing to said subscription-based content messages provided by said content provider service; and
a signal receiver for receiving a signal from said one wireless transceiver caused by the user thereof to be communicated in response to the solicitation, said signal identifying the wireless transceiver for which the content provider is to initiate providing subscription-based content messages.

2. The apparatus as recited in claim 1, further comprising billing means for charging the user of the one wireless transceiver for the subscription-based content messages.

3. The apparatus as recited in claim 1, further comprising a billing interface that records the identification of the one wireless transceiver selected by the user thereof for receiving the subscription-based content messages and periodically generating a demand for payment from the user for said subscription-based content message.

4. The apparatus as recited in claim 3, wherein the billing interface is operatively associated with the communication service.

5. A method for users of wireless transceivers to subscribe selectively to content messages provided periodically to wireless transceivers by a content provider service, comprising the steps of:
(a) providing wireless communication for a plurality of wireless transceivers operated by users of a communication service;
(b) communicating at least one subscription-based content message by a content provider service for communication to and display on selected ones of the plurality of wireless transceivers;
(c) displaying a message from the content provider on at least one message display device available for visual access by said users, said message including a solicitation for subscribing to said at least one subscription-based content message provided by said content provider service; and
(d) communicating a signal from at least one wireless transmitter by the user thereof in response to the solicitation, said signal identifying said one wireless transceiver for which the content provider is to initiate providing subscription-based content messages.

6. The method as recited in claim 5, further comprising the step of (e) billing the user of the one wireless transceiver for the subscription-based content messages.

7. The method as recited in claim 5, further comprising the step of (e) providing a billing interface that records the identification of the one wireless transceiver selected by the user thereof for receiving the subscription-based content messages and periodically generating a demand for payment from the user for said subscription-based content messages.

8. The method as recited in claim 7, wherein the step (e) of providing the billing interface is operatively associated with the communication service.
